(19) United States
(12) Patent Application Publication
(10) Pub. No.: US 2025/0222831 A1
(43) Pub. Date: Jul. 10, 2025

(54) COMMUNICATION APPARATUS, COMMUNICATION SYSTEM, AND SEAT ADJUSTMENT METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Takeo UCHINO, Yokkaichi-Shi, Mie (JP); Kota ODA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/853,545

(22) PCT Filed: Mar. 14, 2023
(86) PCT No.: PCT/JP2023/009741

§ 371 Date: Oct. 2, 2024

(30) Foreign Application Priority Data
Apr. 4, 2022 (JP) 2022-062540

(51) Int. Cl. B60N 2/02; H04M 1/72409

(52) U.S. Cl. CPC B60N 2/0237; H04M 1/724098; B60N 2230/20

(57) ABSTRACT

A plurality of seats are arranged in a vehicle. A communication apparatus is mounted in the vehicle and communicates wirelessly with a mobile terminal. The communication apparatus estimates the position of the mobile terminal inside the vehicle based on information obtained through communication with the mobile terminal, and specifies the seat closest to the estimated position among the plurality of seats. The communication apparatus acquires adjustment data needed for adjusting the specified seat from the mobile terminal.

### CROSS-REFERENCE TO RELATED APPLICATIONS

This application is the U.S. national stage of PCT/JP2023/009741 filed on Mar. 14, 2023, which claims priority of Japanese Patent Application No. JP 2022-062540 filed on Apr. 4, 2022, the contents of which are incorporated herein.

### TECHNICAL FIELD

The present disclosure relates to a communication apparatus, a communication system, and a seat adjustment method.

### BACKGROUND

JP 2017-33320A discloses an adjustment apparatus for adjusting a driver's seat of a vehicle. A storage unit in the vehicle stores, in advance, a plurality of pieces of physique data relating to the physique of each of a plurality of drivers who drive the vehicle. When a driver who drives the vehicle is specified, the adjustment apparatus adjusts the driver's seat based on the physique data of the specified driver. Specifically, the positions in the front-rear direction and the up-down direction of the driver's seat and the like are adjusted.

In JP 2017-33320A, it is necessary to write a plurality of pieces of physique data in a storage unit inside the vehicle in advance.

The present disclosure has been made in consideration of the above circumstances, and aims to provide a communication apparatus, a communication system, and a seat adjustment method that do not require physique data to be written in advance in a storage unit inside the vehicle.

### SUMMARY

A communication apparatus according to an aspect of the present disclosure is a communication apparatus that is configured to wirelessly communicate with a mobile terminal and is to be mounted in a vehicle in which a plurality of seats are arranged, the communication apparatus including a processing unit configured to execute processing, in which the processing unit estimates a position of the mobile terminal inside the vehicle based on information obtained through communication with the mobile terminal, specifies a seat closest to the estimated position among the plurality of seats, and acquires, from the mobile terminal, adjustment data needed to adjust the specified seat.

A communication system according to an aspect of the present disclosure is a communication system including: a mobile terminal; and a communication apparatus configured to communicate wirelessly with the mobile terminal and mounted in a vehicle in which a plurality of seats are arranged, in which the communication apparatus includes a processing unit configured to execute processing, and the processing unit estimates a position of the mobile terminal inside the vehicle based on information obtained through communication with the mobile terminal, specifies a seat closest to the estimated position among the plurality of seats, and acquires, from the mobile terminal, adjustment data needed to adjust the specified seat.

A seat adjustment method according to an aspect of the present disclosure is a seat adjustment method for performing adjustment of one of a plurality of seats arranged in a vehicle, the method to be executed by a computer executing the steps of: estimating, based on information obtained through wireless communication with a mobile terminal, a position of the mobile terminal inside the vehicle; specifying a seat closest to the estimated position among the plurality of seats; and acquiring, from the mobile terminal, adjustment data needed to adjust the specified seat.

Note that the present disclosure can be realized not only as a communication apparatus including such a characteristic processing unit, but also as a seat adjustment method having the characteristic processing as a step, or as a computer program for causing a computer to execute such steps. Also, the present disclosure can be realized as a semiconductor integrated circuit that realizes part or all of a communication apparatus, or as a communication system that includes a communication apparatus.

### Advantageous Effects

According to the above-described aspect, there is no need to write physique data in advance in a storage unit inside the vehicle.

### BRIEF DESCRIPTION OF DRAWINGS

FIG. 1 is a block diagram showing a configuration of a main part of a communication system according to the present embodiment.

FIG. 2 is an explanatory diagram of a vehicle interior.

FIG. 3 is a side view of a seat.

FIG. 4 is a block diagram showing a configuration of a main part of a seat adjuster.

FIG. 5 is a block diagram showing a configuration of a main part of a communication apparatus and a mobile terminal.

FIG. 6 is a table showing contents of adjustment data.

FIG. 7 is a table showing contents of an ID table.

FIG. 8 is a flowchart showing a procedure relating to detection of sitting.

FIG. 9 is a flowchart showing a procedure relating to authentication of a mobile terminal.

FIG. 10 is a flowchart showing a procedure relating to specification of a seat in which a holder of the mobile terminal sits.

FIG. 11 is a flowchart showing a procedure relating to specification of the seat in which the holder of the mobile terminal sits.

FIG. 12 is a flowchart showing a procedure relating to adjustment of a seat.

FIG. 13 is a flowchart showing a procedure relating to adjustment of a seat.

### DETAILED DESCRIPTION OF PREFERRED EMBODIMENTS

First, embodiments of the present disclosure will be listed and described. At least some of the embodiments described below may be combined as appropriate.

A communication apparatus according to an aspect of the present disclosure is a communication apparatus that is configured to wirelessly communicate with a mobile terminal and is to be mounted in a vehicle in which a plurality of seats are arranged, the communication apparatus including a processing unit configured to execute processing, in which the processing unit estimates a position of the mobile terminal inside the vehicle based on information obtained through communication with the mobile terminal, specifies a seat closest to the estimated position among the plurality of seats, and acquires, from the mobile terminal, adjustment data needed to adjust the specified seat.

In the communication apparatus according to an aspect of the present disclosure, the processing unit transmits the adjustment data acquired from the mobile terminal to a seat adjuster configured to adjust the specified seat among a plurality of seat adjusters configured to perform adjustment of the respective plurality of seats.

In the communication apparatus according to an aspect of the present disclosure, the adjustment of the seat includes at least one of adjustment of a position in a front-rear direction of a bottom portion of the seat configured to come into contact with a gluteal region of an occupant of the vehicle, adjustment of a position in an up-down direction of the bottom portion, adjustment of an angle of a backrest that protrudes upward from a rear side of the bottom portion and is configured to come into contact with a back of the occupant, and adjustment of an angle of a headrest that protrudes upward from an upper end portion of the backrest and is configured to come into contact with a head region of the occupant.

In the communication apparatus according to an aspect of the present disclosure, the adjustment data indicates a physique value relating to a physique of a person.

In the communication apparatus according to an aspect of the present disclosure, the processing unit determines whether or not an occupant of the vehicle has sat in one of the plurality of seats, and if the processing unit determines that the occupant of the vehicle has sat in one of the plurality of seats, the processing unit estimates the position of the mobile terminal inside the vehicle based on information obtained through communication with the mobile terminal.

A communication system according to an aspect of the present disclosure includes: a mobile terminal; and a communication apparatus configured to communicate wirelessly with the mobile terminal and mounted in a vehicle in which a plurality of seats are arranged, in which the communication apparatus includes a processing unit configured to execute processing, and the processing unit estimates a position of the mobile terminal inside the vehicle based on information obtained through communication with the mobile terminal, specifies a seat closest to the estimated position among the plurality of seats, and acquires, from the mobile terminal, adjustment data needed to adjust the specified seat.

A seat adjustment method according to an aspect of the present disclosure is a seat adjustment method for performing adjustment of one of a plurality of seats arranged in a vehicle, the method to be executed by a computer executing the steps of: estimating, based on information obtained through wireless communication with a mobile terminal, a position of the mobile terminal inside the vehicle; specifying a seat closest to the estimated position among the plurality of seats; and acquiring, from the mobile terminal, adjustment data needed to adjust the specified seat.

In the communication apparatus, communication system, and seat adjustment method according to the above-described aspects, adjustment data required for seat adjustment is acquired from a mobile terminal, and therefore there is no need to write physique data in advance in a storage unit inside the vehicle. The seat in which the occupant sits is specified based on the position of the mobile terminal, and therefore if the occupant sits in a seat other than the driver's seat, the seat in which the occupant sits is adjusted.

In the communication apparatus according to the above-described aspect, when the occupant of the vehicle is holding the mobile terminal, the seat in which the occupant sits is adjusted by the seat adjuster.

In the communication apparatus according to the above-described aspect, the adjustment of the seat includes at least one of adjustment of the position in the front-rear direction of the bottom portion, adjustment of the position in the up-down direction of the bottom portion, adjustment of the angle of the backrest, and adjustment of the angle of the headrest.

In the communication apparatus according to the above-described aspect, the adjustment data indicates body height, sitting height, leg length, and the like.

In the communication apparatus according to the above-described aspect, the position of the mobile terminal is estimated after the occupant of the vehicle sits in the seat.

A specific example of a communication system according to an embodiment of the present disclosure will be described below with reference to the drawings. Note that the present disclosure is not limited to these examples, and all modifications within the scope and meaning equivalent to the claims are intended to be encompassed therein.

### Communication System Configuration

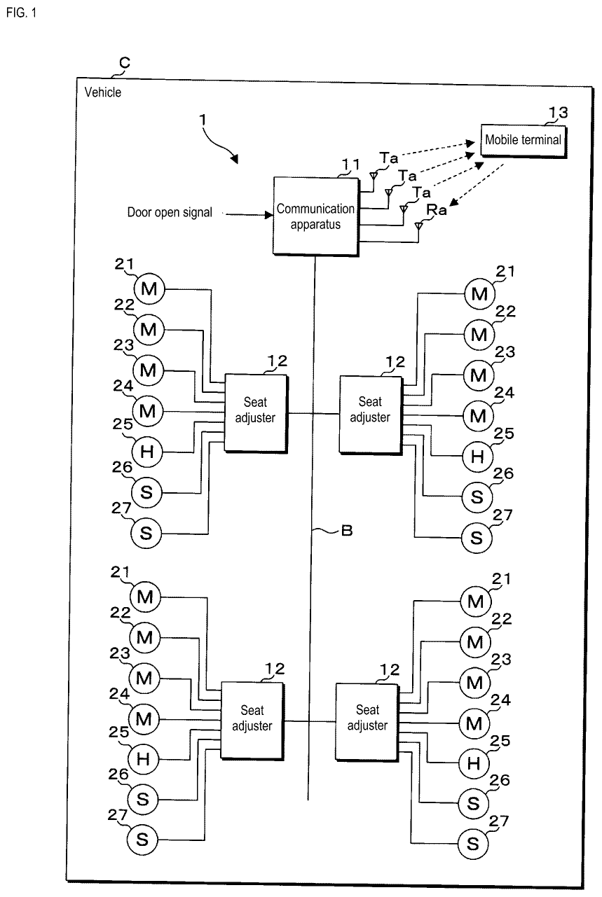

FIG. 1 is a block diagram showing a configuration of a main part of a communication system 1 according to the present embodiment. The communication system 1 includes a communication apparatus 11, four seat adjusters 12, a mobile terminal 13, four front-rear movement motors 21, four up-down movement motors 22, four first rotation motors 23, four second rotation motors 24, four heaters 25, four temperature sensors 26, four sitting sensors 27, three transmission antennas Ta, and a reception antenna Ra. Each of the communication apparatus 11 and the seat adjusters 12 is, for example, an ECU (Electronic Control Unit). The mobile terminal 13 is a smartphone, a mobile phone, an electronic key, a wearable terminal, or the like.

The communication apparatus 11, the four seat adjusters 12, the four front-rear movement motors 21, the four up-down movement motors 22, the four first rotation motors 23, the four second rotation motors 24, the four heaters 25, the four temperature sensors 26, and the four sitting sensors 27 are mounted in a vehicle C. The mobile terminal 13 is carried by a person and moves inside and outside of the vehicle C.

The communication apparatus 11 and the four seat adjusters 12 are connected to a communication bus B. The three transmission antennas Ta and the reception antenna Ra are separately connected to the communication apparatus 11. Furthermore, a front-rear movement motor 21, an up-down movement motor 22, a first rotation motor 23, a second rotation motor 24, a heater 25, a temperature sensor 26, and a sitting sensor 27 are connected to each seat adjuster 12.

The seat adjuster 12, the front-rear movement motor 21, the up-down movement motor 22, the first rotation motor 23, the second rotation motor 24, the heater 25, the temperature sensor 26 and the sitting sensor 27 form one assembly. In the communication system 1, four assemblies are arranged.

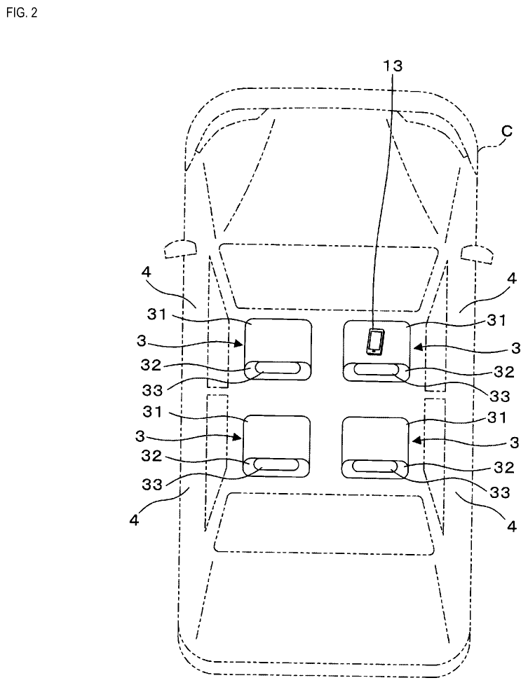

FIG. 2 is an explanatory diagram of the interior of the vehicle C. Four seats 3 are arranged in the interior of the vehicle C. In FIG. 2, a plan view of the four seats 3 is shown. At the front of the interior of the vehicle C, two seats 3 are arranged side by side in the left-right direction. At the rear of the interior of the vehicle C, two seats 3 are also arranged side by side in the left-right direction. One of the four seats 3, for example, the right front seat 3, is the driver's seat. The four assemblies correspond to the four seats 3. The vehicle C is provided with four doors 4. On the right side of the vehicle C, two doors 4 are arranged side by side in the front-rear direction. On the left side of the vehicle C, two doors 4 are also arranged side by side in the front-rear direction.

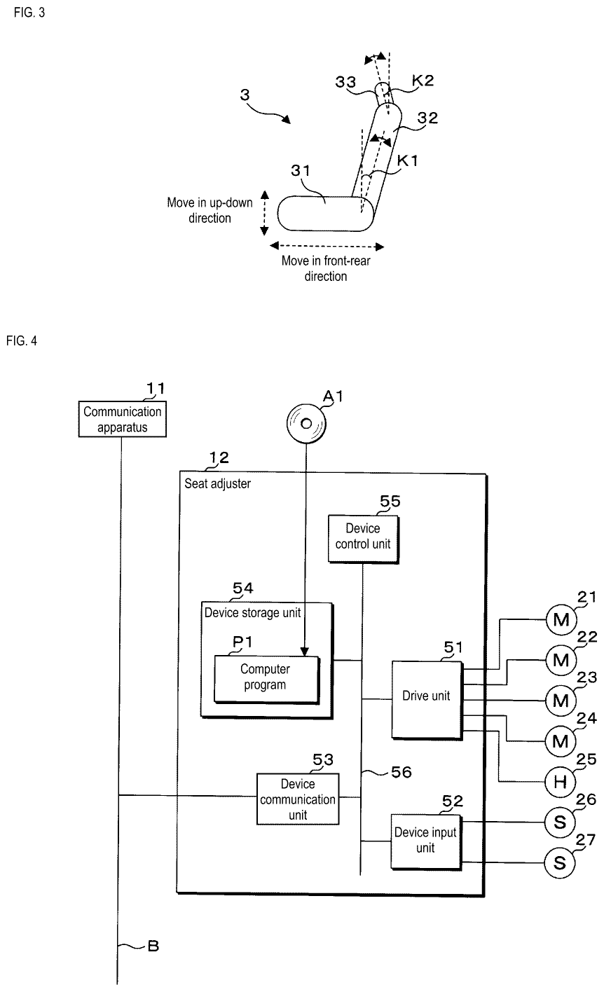

FIG. 3 is a side view of the seat 3. The seat 3 has a cuboid bottom portion 31, a flat backrest 32, and a flat headrest 33. The bottom portion 31 is disposed such that its lower surface opposes the floor of the vehicle C. The backrest 32 protrudes upward from one side located on the rear side of the upper surface of the bottom portion 31. The headrest 33 protrudes upward from the upper end portion of the backrest 32. When an occupant of the vehicle C sits in the seat 3, the gluteal region of the occupant of the vehicle C comes into contact with the upper surface of the bottom portion 31. The back of the occupant of vehicle C comes into contact with the front surface of the backrest 32. The head region of the occupant of the vehicle C comes into contact with the front surface of the headrest 33.

The front-rear movement motor 21 moves the bottom portion 31 in the front-rear direction. The up-down movement motor 22 moves the bottom portion 31 in the up-down direction. The first rotation motor 23 rotates the backrest 32 using one side on the lower side of the backrest 32 as an axis. The first rotation motor 23 adjusts a first angle K1 formed by the up-down direction and the front surface of the backrest 32. The first angle K1 corresponds to the angle of the backrest 32.

The second rotation motor 24 rotates the headrest 33 using one side of the lower side of the headrest 33 as an axis. The second rotation motor 24 adjusts a second angle K2 formed by the up-down direction and the front surface of the headrest 33. The second angle K2 corresponds to the angle of the headrest 33.

The heater 25 includes, for example, an electric heating wire. When an electric current is passed through the electric heating wire, the electric heating wire emits heat, and the temperature around the electric heating wire rises. The heater 25 is disposed, for example, in the bottom portion 31 of the seat 3. In this case, the heater 25 increases the temperature of the bottom portion 31. Hereinafter, the temperature of the portion of the seat 3 that is heated by the heater 25 will be referred to as the seat temperature. The temperature sensor 26 periodically detects the seat temperature. If the heater 25 is disposed in the bottom portion 31, the seat temperature is, for example, the temperature of the upper surface of the bottom portion 31. The amount of heat generated by the heater 25 is adjusted according to the temperature detected by the temperature sensor 26. This allows the seat temperature to be adjusted to a fixed value.

The sitting sensor 27 periodically determines whether or not an occupant is sitting on the bottom portion 31. The sitting sensor 27 detects, for example, pressure applied from above to the upper surface of the bottom portion 31. In this case, the sitting sensor 27 determines that an occupant is sitting when the detected pressure is greater than or equal to a predetermined value. When the detected pressure is less than a predetermined value, the sitting sensor 27 determines that no occupant is sitting.

### Configuration of Seat Adjuster 12

FIG. 4 is a block diagram showing a configuration of a main part of the seat adjuster 12. The four seat adjusters 12 are similarly configured. The seat adjuster 12 adjusts the seat 3 corresponding to the assembly to which the seat adjusted 12 belongs. The seat adjuster 12 includes a drive unit 51, a device input unit 52, a device communication unit 53, a device storage unit 54, and a device control unit 55. These are connected to a device bus 56. The drive unit 51 is further connected to each of the front-rear movement motor 21, the up-down movement motor 22, the first rotation motor 23, the second rotation motor 24, and the heater 25. The device input unit 52 is further connected to each of the temperature sensor 26 and the sitting sensor 27. The device communication unit 53 is further connected to the communication bus B.

The drive unit 51 drives the front-rear movement motor 21, the up-down movement motor 22, the first rotation motor 23, the second rotation motor 24, and the heater 25 in accordance with instructions from the device control unit 55. The drive unit 51 drives the front-rear movement motor 21 to move the bottom portion 31 in the front-rear direction. The drive unit 51 drives the up-down movement motor 22 to move the bottom portion 31 in the up-down direction. The drive unit 51 drives the first rotation motor 23 to adjust the first angle K1. The drive unit 51 drives the second rotation motor 24 to adjust the second angle K2. The drive unit 51 drives the heater 25 to adjust the seat temperature.

As described above, the seat adjuster 12 adjusts the seat 3 corresponding to the assembly to which the seat adjuster 12 belongs. The adjustment of the seat 3 includes adjustment of the position in the front-rear direction of the bottom portion 31, adjustment of the position in the up-down direction of the bottom portion 31, adjustment of the first angle K1, and adjustment of the second angle K2.

Each time the temperature sensor 26 detects the seat temperature, the temperature sensor 26 outputs temperature data indicating the detected seat temperature to the device input unit 52. The sitting sensor 27 outputs, to the device input unit 52, determination result data indicating the determination result every time the sitting sensor 27 determines whether or not an occupant has sat in the seat 3.

The device communication unit 53 communicates with the communication apparatus 11 via the communication bus B. The device communication unit 53 transmits data to the communication apparatus 11 according to an instruction from the device control unit 55. The device communication unit 53 receives data from the communication apparatus 11. Communication via the communication bus B is performed in accordance with a communication protocol such as CAN (Controller Area Network), CAN-FD (Controller Area Network with Flexible Data rate), Ethernet (registered trademark), LIN (Local Interconnect Network), or CXPI (Clock Extension Peripheral Interface).

The device storage unit 54 includes, for example, a volatile memory and a non-volatile memory. The device storage unit 54 stores a computer program P1. The device control unit 55 includes a processing element for executing processing, such as a CPU (Central Processing Unit). The processing element (computer) of the device control unit 55 executes various types of processing in parallel by executing the computer program P1.

Note that the computer program P1 may be provided to the seat adjuster 12 using a non-transitory storage medium A1 on which the computer program P1 is readably stored. The storage medium A1 is, for example, a portable memory. Examples of the portable memory include a CD-ROM, a USB (Universal Serial Bus) memory, an SD card, a micro SD card, and a Compact Flash (registered trademark). If the storage medium A1 is a portable memory, the processing element of the device control unit 55 may read the computer program P1 from the storage medium A1 using a reading apparatus (not shown). The read computer program P1 is written in the device storage unit 54. Furthermore, the computer program P1 may be provided to the seat adjuster 12 by a communication unit (not shown) of the seat adjuster 12 communicating with an external apparatus. In this case, the processing element of the device control unit 55 acquires the computer program P1 through the communication unit. The acquired computer program P1 is written in the device storage unit 54.

The number of processing elements included in the device control unit 55 is not limited to one, and may be two or more. If the device control unit 55 has a plurality of processing elements, the plurality of processing elements may cooperate to execute various types of processing.

### Configuration of Communication Apparatus 11 and Mobile Terminal 13

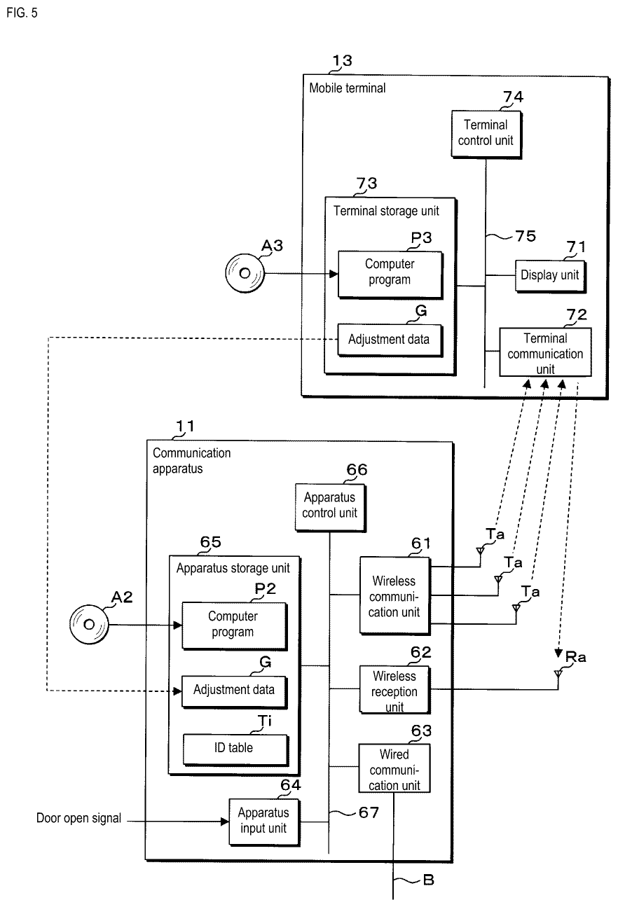

FIG. 5 is a block diagram showing a configuration of a main part of the communication apparatus 11 and the mobile terminal 13. The communication apparatus 11 includes a wireless transmission unit 61, a wireless reception unit 62, a wired communication unit 63, an apparatus input unit 64, an apparatus storage unit 65, and an apparatus control unit 66. These are connected to an apparatus bus 67. The wireless transmission unit 61 is further connected to each of three transmission antennas Ta. The wireless reception unit 62 is further connected to a reception antenna Ra. The wired communication unit 63 is further connected to a communication bus B.

The wireless transmission unit 61 wirelessly transmits data to the mobile terminal 13 via the transmission antennas Ta in accordance with instructions from the apparatus control unit 66. The wireless reception unit 62 receives data wirelessly transmitted from the mobile terminal 13 via the reception antenna Ra. The communication apparatus 11 communicates with the mobile terminal 13 wirelessly. The wireless communication between the communication apparatus 11 and the mobile terminal 13 is performed according to a communication protocol such as Bluetooth (registered trademark), UWB (Ultra Wide Band), Wi-Fi (registered trademark), or LTE (Long Term Evolution). The wired communication unit 63 communicates with the device communication unit 53 of the seat adjuster 12 via the communication bus B. The wired communication unit 63 transmits data to the device communication unit 53 in accordance with an instruction from the apparatus control unit 66. The wired communication unit 63 receives data from the device communication unit 53.

If at least one of the four doors 4 provided on the vehicle C is opened, a door open signal indicating that the door 4 is open is input to the apparatus input unit 64.

The apparatus storage unit 65 includes, for example, a volatile memory and a non-volatile memory. The apparatus storage unit 65 stores a computer program P2. The apparatus control unit 66 has a processing element, such as a CPU, for executing processing. The apparatus control unit 66 functions as a processing unit. The processing element (computer) of the apparatus control unit 66 executes various types of processing in parallel by executing the computer program P2.

Note that the computer program P2 may be provided to the communication apparatus 11 using a non-transitory storage medium A2 on which the computer program P2 is readably stored. The storage medium A2 is, for example, a portable memory. If the storage medium A2 is a portable memory, the processing element of the apparatus control unit 66 may read the computer program P2 from the storage medium A2 using a reading apparatus (not shown). The read computer program P2 is written in the apparatus storage unit 65. Furthermore, the computer program P2 may be provided to the communication apparatus 11 by a communication unit (not shown) of the communication apparatus 11 communicating with an external apparatus. In this case, the processing element of the apparatus control unit 66 acquires the computer program P2 through the communication unit. The acquired computer program P2 is written in the apparatus storage unit 65.

The number of processing elements included in the apparatus control unit 66 is not limited to one, and may also be two or more. If the apparatus control unit 66 has a plurality of processing elements, the plurality of processing elements may cooperate to execute various types of processing.

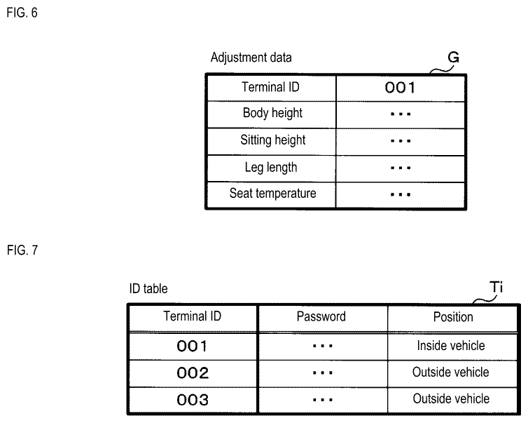

Adjustment data G required for adjusting the seat 3 is written in the apparatus storage unit 65. FIG. 6 is a table showing the contents of the adjustment data G. The adjustment data G is wirelessly transmitted from the mobile terminal 13 to the wireless reception unit 62 of the communication apparatus 11. The adjustment data G indicates a terminal ID for identifying the mobile terminal 13. ID is an abbreviation of Identification Data. The adjustment data G further indicates body height, sitting height, and leg length. These are physique values relating to the physique of the owner (person) of the mobile terminal 13 corresponding to the terminal ID indicated in the adjustment data G. The adjustment data G indicates the seat temperature. This is the seat temperature preferred by the owner of the mobile terminal 13 corresponding to the terminal ID indicated in the adjustment data G.

The apparatus storage unit 65 further stores an ID table Ti in advance. FIG. 7 is a diagram showing the contents of the ID table Ti. In the ID table Ti, a plurality of terminal IDs are shown. A plurality of passwords corresponding to the plurality of terminal IDs are stored. The terminal IDs and passwords are registered in advance by the user of the vehicle C. In the ID table Ti, the positions of the mobile terminals 13 corresponding to the terminal IDs are shown. The position column of the ID table Ti indicates whether or not the mobile terminals 13 are located inside the vehicle. The positions in the ID table Ti are changed by the apparatus control unit 66.

As shown in FIG. 5, the mobile terminal 13 includes a display unit 71, a terminal communication unit 72, a terminal storage unit 73, and a terminal control unit 74. These are connected to a terminal bus 75. The display unit 71 is, for example, a touch panel. The display unit 71, in accordance with instructions from the terminal control unit 74, displays an input screen for receiving input from the user, an answer screen for receiving an answer from the user, and the like.

The terminal communication unit 72 receives data wirelessly transmitted by the wireless transmission unit 61 of the communication apparatus 11. The terminal communication unit 72 wirelessly transmits data to the wireless reception unit 62 of the communication apparatus 11 according to an instruction from the terminal control unit 74.

The terminal storage unit 73 includes, for example, a volatile memory and a non-volatile memory. The terminal storage unit 73 stores a computer program P3. The terminal control unit 74 has a processing element for executing processing, such as a CPU. The processing element (computer) of the terminal control unit 74 executes various types of processing in parallel by executing the computer program P3.

Note that the computer program P3 may be provided to the mobile terminal 13 by using a non-transitory storage medium A3 on which the computer program P3 is readably stored. The storage medium A3 is, for example, a portable memory. If the storage medium A3 is a portable memory, the processing element of the terminal control unit 74 may read the computer program P3 from the storage medium A3 using a reading apparatus (not shown). The read computer program P3 is written in the terminal storage unit 73. Furthermore, the computer program P3 may be provided to the mobile terminal 13 by a communication unit (not shown) of the mobile terminal 13 communicating with an external apparatus. In this case, the processing element of the mobile terminal 13 acquires the computer program P3 through the communication unit. The acquired computer program P3 is written in the terminal storage unit 73.

The number of processing elements included in the terminal control unit 74 is not limited to one, and may be two or more. If the terminal control unit 74 has a plurality of processing elements, the plurality of processing elements may cooperate to execute various types of processing.

The terminal storage unit 73 stores the adjustment data G in advance. A user of the mobile terminal 13 registers his or her body height, sitting height, leg length, and seat temperature in advance. The terminal ID indicated by the adjustment data G is the terminal ID of the mobile terminal 13 in which the adjustment data G is stored.

### Operations of Communication Apparatus 11, Seat Adjuster 12, and Mobile Terminal 13

Operations of the communication apparatus 11, the seat adjuster 12 and the mobile terminal 13 will be described. In the following, the processing executed by the device control unit 55 of the seat adjuster 12 is processing realized by executing the computer program P1. The processing executed by the apparatus control unit 66 of the communication apparatus 11 is realized by executing the computer program P2. The processing executed by the terminal control unit 74 of the mobile terminal 13 is realized by executing the computer program P3.

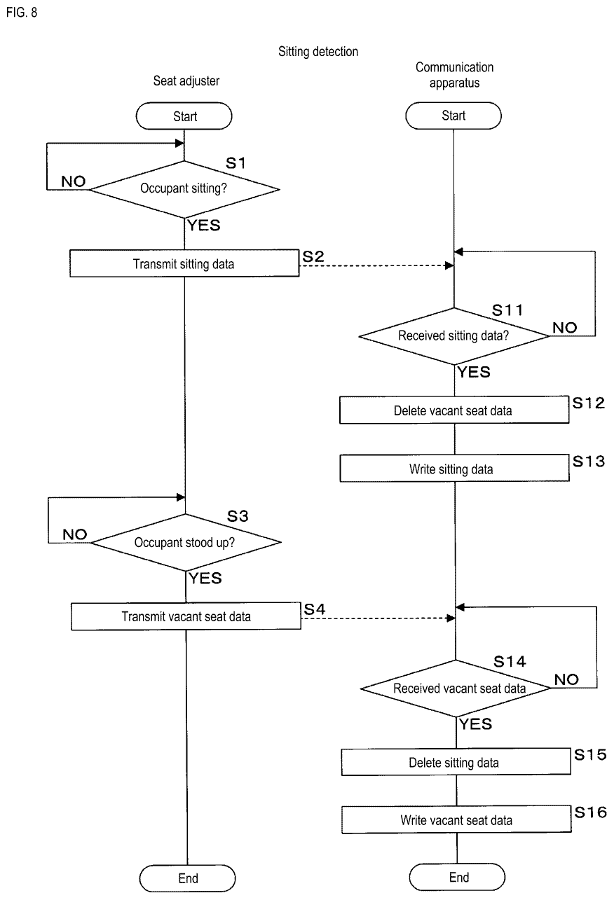

FIG. 8 is a flowchart showing a procedure relating to detection of sitting. The device control unit 55 of each seat adjuster 12 executes sitting detection processing for detecting an occupant sitting in the seat 3 corresponding to the assembly to which the device control unit 55 belongs. Accordingly, four instances of sitting detection processing correspond to the four seats 3, respectively. The apparatus control unit 66 of the communication apparatus 11 executes four instances of writing processing corresponding to the four instances of sitting detection processing. Writing processing is processing for writing data. The four instances of writing processing correspond to the four seats 3. In the apparatus storage unit 65, sitting data or vacant seat data for each of the four seats 3 is stored. The sitting data indicates that an occupant is sitting in the seat 3 corresponding to the sitting data. The vacant seat data indicates that no occupant is sitting in the seat 3 corresponding to the vacant seat data.

In sitting detection processing, the device control unit 55 determines whether or not an occupant of the vehicle C has sat in the seat 3 corresponding to the sitting detection processing based on the determination result data input from the sitting sensor 27 to the device input unit 52 (step S1). In step S1, if the determination result data periodically input to the device input unit 52 changes from “not sitting” to “sitting”, the device control unit 55 determines that an occupant has sat.

If it is determined that no occupant is sitting (S1: NO), the device control unit 55 executes step S1 again and waits until an occupant sits. If the device control unit 55 determines that an occupant has sat (S1: YES), the device control unit 55 instructs the device communication unit 53 to transmit sitting data indicating that an occupant is sitting in the seat 3 corresponding to the sitting detection processing currently being executed, to the wired communication unit 63 of the communication apparatus 11 (step S2).

The writing processing is executed while the vacant seat data of the seat 3 corresponding to the writing processing is stored in the apparatus storage unit 65. In the writing processing, the apparatus control unit 66 determines whether or not the wired communication unit 63 has received the sitting data from the device communication unit 53 of the seat adjuster 12 (step S11). If the apparatus control unit 66 determines that the wired communication unit 63 has not received the sitting data (S11: NO), the apparatus control unit 66 executes step S11 again and waits until the wired communication unit 63 receives the sitting data.

If the apparatus control unit 66 determines that the wired communication unit 63 has received the sitting data (S11: YES), the apparatus control unit 66 deletes the vacant seat data for the seat 3 corresponding to the writing processing currently being executed, from the apparatus storage unit 65 (step S12), and writes the sitting data received by the wired communication unit 63 to the apparatus storage unit 65 (step S13).

In the sitting detection processing, after executing step S2, the device control unit 55 determines whether or not the occupant of the vehicle C has stood up (step S3). In step S3, if the determination result data periodically input to the device input unit 52 changes from “sitting” to “not sitting”, the device control unit 55 determines that the occupant has stood up. If it is determined that the occupant has not stood up (S3: NO), the device control unit 55 executes step S3 again and waits until the occupant stands up.

If the device control unit 55 determines that the occupant has stood up (S3: YES), the device control unit 55 instructs the device communication unit 53 to transmit vacant seat data indicating vacancy of the seat 3 corresponding to the sitting detection processing currently being executed, to the wired communication unit 63 of the communication apparatus 11 (step S4). After executing step S4, the device control unit 55 ends the sitting detection processing. After ending the sitting detection processing, the device control unit 55 executes the sitting detection processing again.

In the writing processing, after executing step S13, the apparatus control unit 66 determines whether or not the wired communication unit 63 has received vacant seat data for the seat 3 corresponding to the writing processing currently being executed (step S14). If the apparatus control unit 66 determines that the wired communication unit 63 has not received the vacant seat data (S14: NO), the apparatus control unit 66 executes step S14 again and waits until the wired communication unit 63 receives the vacant seat data. If the apparatus control unit 66 determines that the wired communication unit 63 has received vacant seat data (S14: YES), the apparatus control unit 66 deletes the sitting data of the seat 3 corresponding to the writing processing currently being executed, from the apparatus storage unit 65 (step S15), and writes the vacant seat data received by the wired communication unit 63 in the apparatus storage unit 65 (step S16). After executing step S16, the apparatus control unit 66 ends the writing processing. Thereafter, the apparatus control unit 66 executes the writing processing again.

As described above, the four instances of sitting detection processing and the four instances of writing processing are executed, and therefore the apparatus storage unit 65 of the communication apparatus 11 stores sitting data or vacant seat data for each of the four seats. Based on the data stored in the apparatus storage unit 65, the apparatus control unit 66 can determine whether or not an occupant is sitting in each of the four seats.

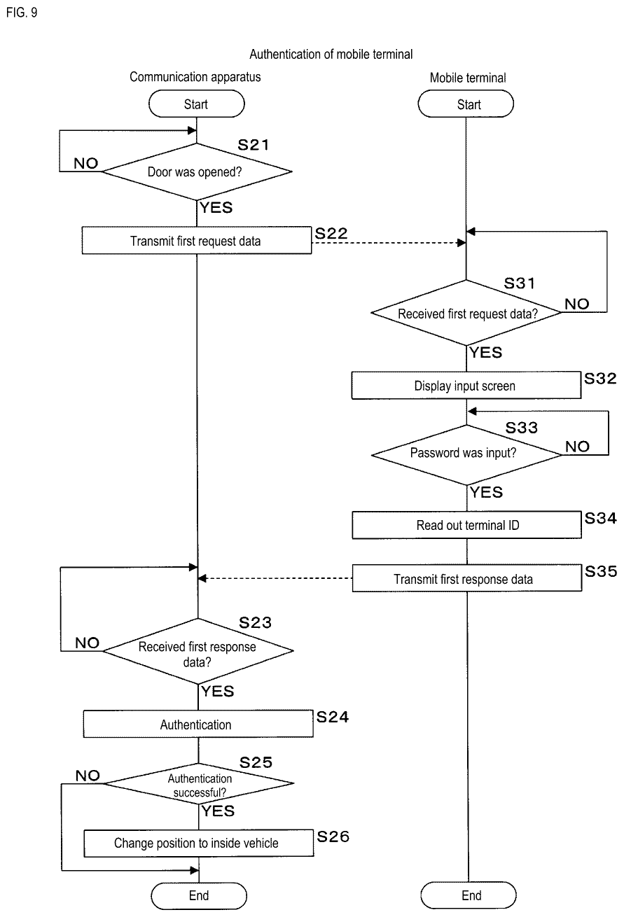

FIG. 9 is a flowchart showing a procedure for authenticating the mobile terminal 13. The apparatus control unit 66 of the communication apparatus 11 executes authentication processing for authenticating the mobile terminal 13. The terminal control unit 74 of the mobile terminal 13 executes first response processing for transmitting first response data indicating the terminal ID and the password. In the apparatus storage unit 65 of the mobile terminal 13, the terminal ID of the mobile terminal 13 is stored.

In the authentication processing, the apparatus control unit 66 determines whether or not at least one of the four doors 4 is open based on whether or not a door open signal has been input to the apparatus input unit 64 (step S21). If the apparatus control unit 66 determines that no door 4 is open (S21: NO), the apparatus control unit 66 executes step S21 again and waits until at least one door 4 is opened. If the apparatus control unit 66 determines that a door 4 is open (S21: YES), the apparatus control unit 66 instructs the wireless transmission unit 61 to transmit, via one transmission antenna Ta, first request data requesting the transmission of first response data indicating a terminal ID and password (step S22).

Here, the transmission region in which the first request data is transmitted via the transmission antenna Ta matches the region in the vehicle interior. Here, “match” means “substantially match”. Accordingly, if the difference between the transmission region and the region in the vehicle interior is within an error range, the transmission region and the region in the vehicle interior match each other.

In the first response processing, the terminal control unit 74 of the mobile terminal 13 determines whether or not the terminal communication unit 72 has received the first request data from the wireless transmission unit 61 of the communication apparatus 11 (step S31). If the terminal control unit 74 determines that the terminal communication unit 72 has not received the first request data (S31: NO), the terminal control unit 74 executes step S31 again and waits until the terminal communication unit 72 receives the first request data. If the terminal control unit 74 determines that the terminal communication unit 72 has received the first request data (S31: YES), the terminal control unit 74 causes the display unit 71 to display an input screen for inputting a password (step S32). The user of the mobile terminal 13 inputs a password on the input screen.

Next, the terminal control unit 74 determines whether or not a password has been input on the input screen (step S33). If the terminal control unit 74 determines that a password has not been input (S33: NO), the terminal control unit 74 executes step S33 again and waits until a password is input. If a password is not input before the elapse of a fixed period after step S32 is executed, the terminal control unit 74 ends the first response processing. The period that has elapsed since step S32 was executed is measured by, for example, a timer (not shown).

If the terminal control unit 74 determines that a password has been input (S33: YES), the terminal control unit 74 reads out the terminal ID from the terminal storage unit 73 (step S34). Next, the terminal control unit 74 instructs the terminal communication unit 72 to transmit first response data indicating the password input on the input screen and the terminal ID read out in step S34 to the wireless reception unit 62 of the communication apparatus 11 (step S35). After executing step S35, the terminal control unit 74 ends the first response processing. After ending the first response processing, the terminal control unit 74 executes the first response processing again.

In the authentication processing, after executing step S22, the apparatus control unit 66 of the communication apparatus 11 determines whether or not the wireless reception unit 62 has received the first response data from the terminal communication unit 72 of the mobile terminal 13 (step S23). If the apparatus control unit 66 determines that the wireless reception unit 62 has not received the first response data (S23: NO), the apparatus control unit 66 executes step S23 again and waits until the wireless reception unit 62 receives the first response data. If the wireless reception unit 62 does not receive the first response data before the elapse of a second fixed period after step S22 is executed, the apparatus control unit 66 ends the authentication processing. The second fixed period is longer than the fixed period. The period that has elapsed since step S22 was executed is measured by, for example, a timer (not shown).

If the apparatus control unit 66 determines that the wireless reception unit 62 has received the first response data (S23: YES), the apparatus control unit 66 authenticates the mobile terminal 13 based on the terminal ID and password indicated by the first response data received by the wireless reception unit 62 (step S24). If the terminal ID indicated by the first response data matches one of the plurality of terminal IDs indicated in the ID table Ti and the password indicated by the first response data matches the password corresponding to the matching terminal ID in the ID table Ti, the authentication is successful.

If the terminal ID indicated by the first response data is not included in the plurality of terminal IDs indicated in the ID table Ti, the authentication fails. Even if the terminal ID indicated by the first response data matches one of the plurality of terminal IDs indicated in the ID table Ti, if the password indicated by the first response data does not match the password corresponding to the matching terminal ID in the ID table Ti, the authentication fails.

Note that the information used for authentication may also be only the terminal ID. In this case, in the first response processing, steps S32 and S33 are omitted. If the terminal control unit 74 of the mobile terminal 13 determines that the terminal communication unit 72 has received the first request data (S31: YES), the terminal control unit 74 executes step S34. In this case, in step S24 of the authentication processing, if the terminal ID indicated by the first response data matches one of the plurality of terminal IDs indicated in the ID table Ti, the authentication is successful. If the terminal ID indicated by the first response data is not included in the plurality of terminal IDs indicated in the ID table Ti, the authentication fails. In this configuration, the password column is not necessary in the ID table Ti.

After executing step S24, the apparatus control unit 66 determines whether or not the authentication was successful (step S25). If the apparatus control unit 66 determines that the authentication was successful (S25: YES), the apparatus control unit 66 changes the position in the ID table Ti corresponding to the terminal ID indicated by the first response data to inside the vehicle (step S26). If the apparatus control unit 66 determines that the authentication was not successful (S25: NO), or after step S26 is executed, the apparatus control unit 66 ends the authentication processing. After ending the authentication processing, the apparatus control unit 66 executes the authentication processing again.

As described above, if the door 4 is opened, authentication of the mobile terminal 13 is performed. If the authentication is successful, the mobile terminal 13 is considered to be present inside the vehicle, in the ID table Ti.

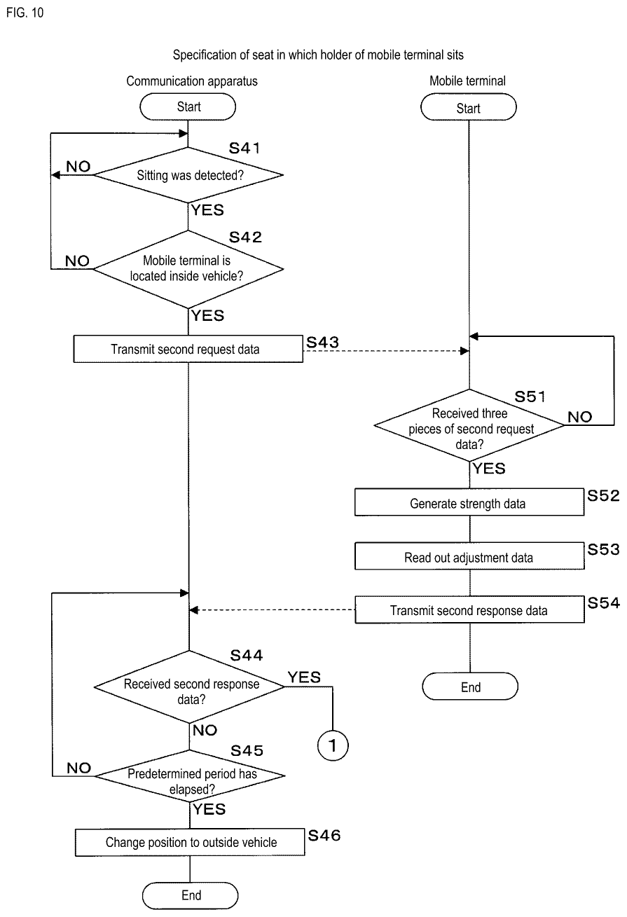

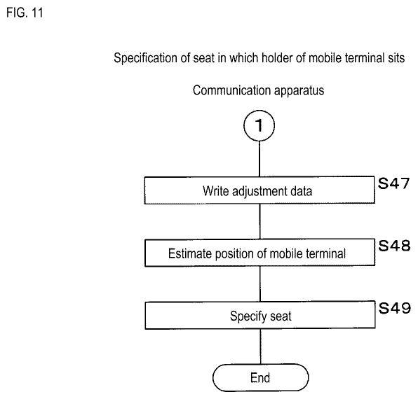

FIGS. 10 and 11 are flowcharts showing a procedure for specifying the seat 3 in which the holder of the mobile terminal 13 sits. The apparatus control unit 66 of the communication apparatus 11 executes seat specification processing for specifying the seat 3 in which the holder of the mobile terminal 13 sits. The mobile terminal 13 executes second response processing for transmitting second response data including the adjustment data G.

In the seat specification processing, the apparatus control unit 66 determines whether or not sitting has been detected in one of the four seats 3 based on the data stored in the apparatus storage unit 65 (step S41). In step S41, when the data stored in the apparatus storage unit 65 for one of the four seats 3 is changed from vacant seat data to sitting data, the apparatus control unit 66 determines that sitting has been detected. If no sitting is detected in any of the four seats 3 (S41: NO), the apparatus control unit 66 executes step S41 again and waits until an occupant sits in a seat 3.

If the apparatus control unit 66 determines that sitting has been detected (S41: YES), the apparatus control unit 66 determines whether or not a mobile terminal 13 whose terminal ID is shown in the ID table Ti is located inside the vehicle (step S42). If it is determined that the mobile terminal 13 is not located inside the vehicle (S42: NO), the apparatus control unit 66 executes step S41 again and waits until an occupant sits in the seat 3.

If the apparatus control unit 66 determines that the mobile terminal 13 is located inside the vehicle (S42: YES), the apparatus control unit 66 instructs the wireless transmission unit 61 to transmit second request data requesting the transmission of second response data including strength data and the adjustment data G to the terminal communication unit 72 of the mobile terminal 13 whose terminal ID is shown in the ID table Ti, via the three transmission antennas Ta (step S43). Specifically, three wireless signals including the second request data are transmitted sequentially via the three respective transmission antennas Ta. For the three respective wireless signals, three signal strengths at the time of transmission match. Here, “match” means “substantially match”. If the differences between the maximum and minimum values of the three signal strengths are within the error range, the three signal strengths match.

When the terminal communication unit 72 of the mobile terminal 13 receives the second request data, the terminal communication unit 72 detects the reception strength of the wireless signal including the second request data. The longer the propagation distance of a wireless signal is, the greater the attenuation of the signal strength of the wireless signal is. Accordingly, the longer the propagation distance of a wireless signal is, the weaker the reception strength of the wireless signal is. The distance from the transmission antenna Ta to the mobile terminal 13 can be calculated based on the reception strength of the wireless signal.

In the second response processing, the terminal control unit 74 of the mobile terminal 13 determines whether or not the terminal communication unit 72 has received three pieces of second request data transmitted via the three transmission antennas Ta (step S51). If the terminal control unit 74 determines that the terminal communication unit 72 has not received the three pieces of second request data (S51: NO), the terminal control unit 74 executes step S51 again and waits until the terminal communication unit 72 receives the three pieces of second request data. After the second response processing is started, if the third piece of second request data is not received before the elapse of a third fixed period after the terminal communication unit 72 receives the first piece of second request data, the second response processing is ended. The period that has elapsed since the first piece of second request data was received is measured by, for example, a timer (not shown).

If the terminal control unit 74 determines that the terminal communication unit 72 has received three pieces of second request data (S51: YES), the terminal control unit 74 generates strength data indicating the reception strengths of the three wireless signals respectively including the three pieces of second request data (step S52). After executing step S52, the terminal control unit 74 reads out the adjustment data G from the apparatus storage unit 65 (step S53). Next, the terminal control unit 74 instructs the terminal communication unit 72 to transmit the second response data including the strength data generated in step S52 and the adjustment data read out in step S53 to the wireless reception unit 62 of the communication apparatus 11 (step S54). After executing step S54, the terminal control unit 74 ends the second response processing. After ending the second response processing, the terminal control unit 74 executes the second response processing again.

In the seat specification processing, after executing step S43, the apparatus control unit 66 of the communication apparatus 11 determines whether or not the wireless reception unit 62 has received the second response data (step S44). If the apparatus control unit 66 determines that the wireless reception unit 62 has not received the second response data (S44: NO), the apparatus control unit 66 determines whether or not a fixed predetermined period has elapsed since step S43 was executed (step S45). If the apparatus control unit 66 determines that the predetermined period has not elapsed (S45: NO), the apparatus control unit 66 executes step S44 again. The apparatus control unit 66 waits until the second response data is received or the predetermined period has elapsed. The period that has elapsed since step S43 was executed is measured by, for example, a timer (not shown).

If the apparatus control unit 66 determines that the predetermined period has elapsed (S45: YES), the apparatus control unit 66 changes the position in the ID table Ti corresponding to the terminal ID of the mobile terminal 13 to which the second request data has been transmitted to outside the vehicle (step S46). The predetermined period is longer than a third fixed period. After executing step S46, the apparatus control unit 66 ends the seat specification processing.

If the apparatus control unit 66 determines that the wireless reception unit 62 has received the second response data (S44: YES), the apparatus control unit 66 writes the adjustment data G included in the second response data received by the wireless reception unit 62 in the apparatus storage unit 65 (step S47). As a result, the adjustment data G stored in the terminal storage unit 73 of the mobile terminal 13 is written in the apparatus storage unit 65 of the communication apparatus 11. The apparatus control unit 66 acquires the adjustment data G from the terminal communication unit 72 of the mobile terminal 13. Next, the apparatus control unit 66 estimates the position of the mobile terminal 13 inside the vehicle C based on the three reception strengths indicated by the strength data included in the second response data received by the wireless reception unit 62 (step S48). The reception strength of the wireless signal including the second request data is information obtained through communication between the communication apparatus 11 and the mobile terminal 13.

As described above, the propagation distance from one transmission antenna Ta to the mobile terminal 13 is calculated based on one reception strength. Three propagation distances for the three transmission antennas Ta are calculated based on the three reception strengths. The position of the mobile terminal 13 inside the vehicle C is estimated based on the three calculated propagation distances.

Next, the apparatus control unit 66 specifies the seat 3 in which the holder of the mobile terminal 13 sits among the four seats 3, based on the position estimated in step S48 (step S49). The seat 3 specified in step S49 is the seat 3 among the four seats 3 that is the closest to the position estimated in step S48. The positions of the four seats 3 in the vehicle C are stored in the apparatus storage unit 65. After executing step S49, the apparatus control unit 66 ends the seat specification processing. After ending the seat specification processing, the apparatus control unit 66 executes the seat specification processing again.

Note that the calculation of the distance between the transmission antenna Ta and the mobile terminal 13 is not limited to calculation based on the reception strength. For example, if the transmission antenna Ta also functions as a reception antenna, when the terminal communication unit 72 receives a wireless signal, the terminal communication unit 72 transmits the wireless signal. The distance can be calculated based on the length of the period from when a wireless signal is transmitted via the transmission antenna Ta to when the wireless signal is received via the transmission antenna Ta. It is assumed that the propagation speed of a wireless signal is 3 times 10 to the power of 8 m/s. The distance between the transmission antenna Ta and the mobile terminal 13 is calculated by dividing the product of the propagation speed and the period by two.

In calculating the distance between the transmission antenna Ta and the mobile terminal 13, a distance measuring technique such as Bluetooth (registered trademark), UWB, GPS (Global Positioning System), or Wi-Fi (registered trademark) may be used.

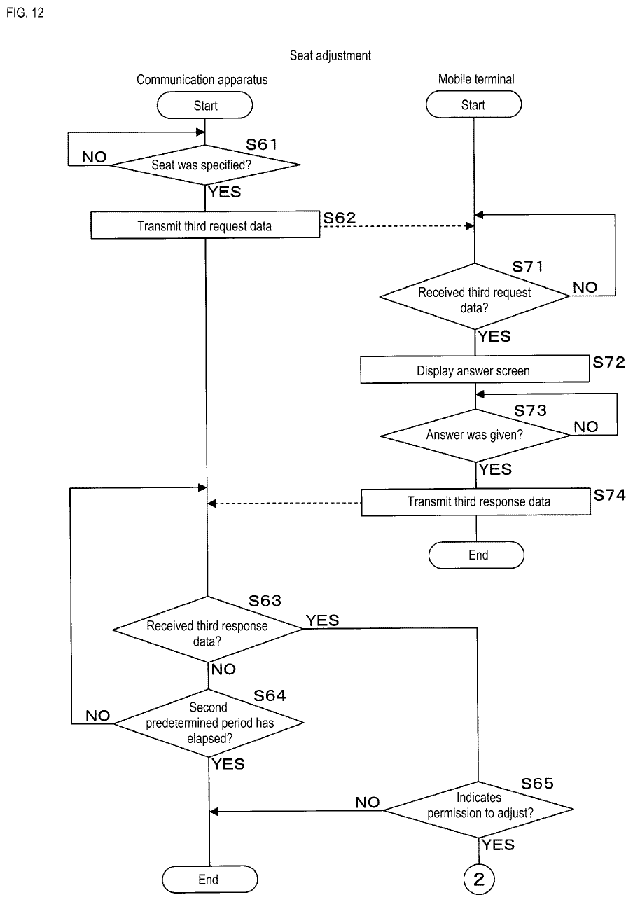

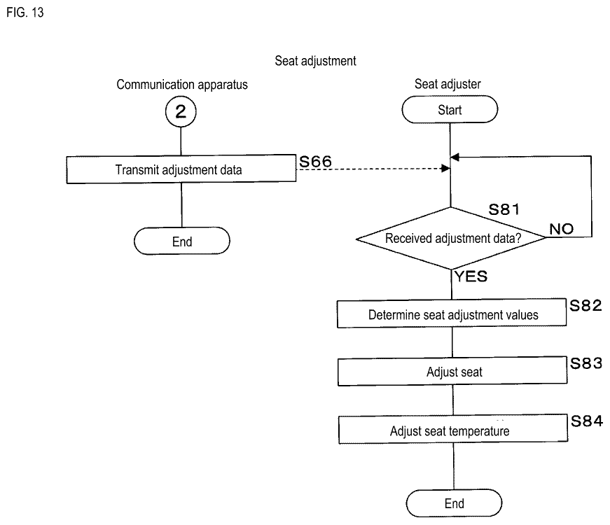

FIGS. 12 and 13 are flowcharts showing a procedure for adjusting the seat 3. The apparatus control unit 66 of the communication apparatus 11 executes data transmission processing for transmitting the adjustment data G. The terminal control unit 74 of the mobile terminal 13 executes third response processing for transmitting third response data indicating a response as to whether or not the seat 3 is allowed to be adjusted. The device control unit 55 of each of the four seat adjusters 12 executes seat adjustment processing for adjusting the seat 3.

In the data transmission processing, the apparatus control unit 66 first determines whether or not the seat 3 in which the holder of the mobile terminal 13 sits has been specified in the seat specification processing (step S61). If the apparatus control unit 66 determines that the seat 3 has not been specified (S61: NO), the apparatus control unit 66 executes step S61 again and waits until the seat 3 in which the holder of the mobile terminal 13 sits is specified. If the apparatus control unit 66 determines that the seat 3 has been specified (S61: YES), the apparatus control unit 66 instructs the wireless transmission unit 61 to transmit third request data requesting the transmission of the third response data (step S62). Here, the wireless transmission unit 61 wirelessly transmits the third request data via one transmission antenna Ta.

In the third response processing, the terminal control unit 74 of the mobile terminal 13 determines whether or not the terminal communication unit 72 has received third request data from the wireless transmission unit 61 (step S71). If the terminal control unit 74 determines that the terminal communication unit 72 has not received the third request data (S71: NO), the terminal control unit 74 executes step S71 again and waits until the terminal communication unit 72 receives the third request data. If the terminal control unit 74 determines that the terminal communication unit 72 has received the third request data (S71: YES), the terminal control unit 74 causes the display unit 71 to display an answer screen for answering whether or not to allow adjustment of the seat 3 specified by the apparatus control unit 66 in the seat specification processing (step S72). On the answer screen, for example, the seat 3 specified by the apparatus control unit 66 in the seat specification processing and two buttons respectively labeled “Allow” and “Do not allow” are displayed. The user of the mobile terminal 13 gives an answer on the answer screen. For example, the user selects the “Allow” or “Do not allow” button on the answer screen.

Next, the terminal control unit 74 determines whether or not an answer has been given on the answer screen (step S73). If it is determined that no answer has been given (S73: NO), the terminal control unit 74 executes step S73 again and waits until an answer is given. If no answer is given before the elapse of a fourth fixed period after step S72 is executed, the terminal control unit 74 ends the third response processing. The period that has elapsed since step S72 was executed is measured by, for example, a timer (not shown).

If it is determined that an answer has been given (S73: YES), the terminal control unit 74 causes the third response data indicating the answer given on the answer screen to be transmitted to the wireless reception unit 62 of the communication apparatus 11 (step S74). After executing step S74, the terminal control unit 74 ends the third response processing. After ending the third response processing, the terminal control unit 74 executes the third response processing again.

In the seat adjustment processing, after executing step S62, the apparatus control unit 66 of the communication apparatus 11 determines whether or not the wireless reception unit 62 has received the third response data from the terminal communication unit 72 of the mobile terminal 13 (step S63). If the apparatus control unit 66 determines that the wireless reception unit 62 has not received the third response data (S63: NO), the apparatus control unit 66 determines whether or not a fixed second predetermined period has elapsed since step S62 was executed (step S64). If the apparatus control unit 66 determines that the second predetermined period has not elapsed (S64: NO), the apparatus control unit 66 executes step S64 again. The apparatus control unit 66 waits until the wireless reception unit 62 receives the third response data or until the second predetermined period has elapsed. The second predetermined period is longer than the fourth fixed period. The period that has elapsed since step S62 was executed is measured, for example, by a timer (not shown).

If the apparatus control unit 66 determines that the wireless reception unit 62 has received the third response data (S63: YES), the apparatus control unit 66 determines whether or not the third response data received by the wireless reception unit 62 indicates permission to adjust the seat 3 (step S65). If the apparatus control unit 66 determines that the second predetermined period has elapsed (S64: YES), or if the apparatus control unit 66 determines that the third response data does not indicate permission to adjust the seat 3 (S65: NO), the apparatus control unit 66 ends the seat adjustment processing.

If the apparatus control unit 66 determines that the third response data indicates permission to adjust the seat 3 (S65: YES), the apparatus control unit 66 instructs the wired communication unit 63 to transmit the adjustment data G written in the apparatus storage unit 65 in step S47 of the seat specification processing to the seat adjuster 12 that adjusts the seat 3 specified in step S49 of the seat specification processing (step S66). After executing step S66, the apparatus control unit 66 ends the data transmission processing. After ending the data transmission processing, the apparatus control unit 66 executes the data transmission processing again.

In the seat adjustment processing, the device control unit 55 of the seat adjuster 12 determines whether or not the device communication unit 53 has received adjustment data G whose destination is the seat adjuster 12 (step S81). If the device control unit 55 determines that the device communication unit 53 has not received the adjustment data G (S81: NO), the device control unit 55 executes step S81 again and waits until the device communication unit 53 receives the adjustment data G whose destination is the seat adjuster 12.

If the device control unit 55 determines that the device communication unit 53 has received the adjustment data G (S81: YES), the device control unit 55 determines the seat adjustment value based on the physique value indicated by the adjustment data G received by the device communication unit 53 (step S82). Body height, sitting height, and leg length are all physique values. The position in the front-rear direction of the bottom portion 31 of the seat 3, the position in the up-down direction of the bottom portion 31, the first angle K1, and the second angle K2 are each a seat adjustment value. Accordingly, in step S82, four seat adjustment values are determined based on the three physique values.

After executing step S82, the device control unit 55 instructs the drive unit 51 to adjust the seat 3 corresponding to the assembly to which the seat adjuster 12 belongs (step S83). The seat 3 adjusted in step S83 is the seat 3 specified by the apparatus control unit 66 of the communication apparatus 11 in the seat specification processing. If the occupant of the vehicle C is carrying a mobile terminal 13, the seat 3 to be adjusted in step S83 is the seat in which the occupant sits. In the adjustment of the seat 3, the position of the bottom portion 31 in the front-rear direction, the position of the bottom portion 31 in the up-down direction, the first angle K1, and the second angle K2 are each adjusted to the values determined in step S82.

After executing step S83, the device control unit 55 instructs the drive unit 51 to adjust the seat temperature of the seat 3 corresponding to the assembly to which the seat adjuster 12 belongs, to the seat temperature indicated by the adjustment data G received by the device communication unit 53 (step S84). The drive unit 51 adjusts the amount of heat generated by the heater 25 such that the seat temperature detected by the temperature sensor 26 reaches the seat temperature indicated by the adjustment data. After executing step S84, the device control unit 55 ends the seat adjustment processing. After ending the seat adjustment processing, the device control unit 55 executes the seat adjustment processing again.

As described above, in the vehicle C, the seat 3 closest to the mobile terminal 13 is adjusted according to the physique value indicated by the adjustment data G stored in the mobile terminal 13. The seat temperature of the seat 3 closest to the mobile terminal 13 is adjusted to the seat temperature indicated by the adjustment data G stored in the mobile terminal 13.

In the communication system 1, the apparatus control unit 66 of the communication apparatus 11 acquires the adjustment data G from the terminal communication unit 72 of the mobile terminal 13. For this reason, it is not necessary to write the adjustment data G in advance in the apparatus storage unit 65 of the communication apparatus 11 mounted in the vehicle C. The seat 3 in which the occupant of the vehicle C sits is specified based on the location of the mobile terminal 13, and therefore if the occupant sits in a seat 3 other than the driver's seat, the seat 3 in which the occupant sits is adjusted.

When a seat 3 becomes vacant, the apparatus control unit 66 of the communication apparatus 11 may delete from the apparatus storage unit 65 the adjustment data G that was used to adjust the seat 3 that became vacant. After the seat 3 becomes vacant, if the occupant of the vehicle C sits in another seat 3, the apparatus control unit 66 again acquires the adjustment data G from the mobile terminal 13 carried by the occupant. The seat adjuster 12 adjusts the seat 3 in which the occupant sits, in accordance with the adjustment data G acquired by the apparatus control unit 66. If the seat 3 becomes vacant, the drive unit 51 stops driving the heater 25.

### Modified Examples

The wired communication unit 63 of the communication apparatus 11 communicates with the device communication unit 53 of each of the four seat adjusters 12 via the communication bus B. However, the wired communication unit 63 may also be connected to each of the four device communication units 53 separately. In this case, the wired communication unit 63 communicates with the four device communication units 53 individually. Also, the communication between the wired communication unit 63 and the device communication units 53 is not limited to wired communication. The wired communication unit 63 may also communicate with each of the four device communication units 53 wirelessly.

The number of seats 3 arranged in the vehicle C is not limited to four. The number of seats 3 may be two, three, five, or more. The number of assemblies arranged in the communication system 1 matches the number of seats 3. The number of transmission antennas Ta is not limited to three, and may be two, four, or more. The adjustment data G is not limited to data indicating physique values relating to a person's physique, and may be, for example, data indicating the position in the front-rear direction of the bottom portion 31, the position in the up-down direction of the bottom portion 31, the first angle K1, and the second angle K2. When adjusting the seat 3, the seat adjuster 12 does not need to adjust all of the position in the front-rear direction of the bottom portion 31, the position in the up-down direction of the bottom portion 31, the first angle K1, and the second angle K2. As long as the seat adjuster 12 performs at least one of these adjustments, there is no problem.

The disclosed embodiments are to be considered in all respects as illustrative and not restrictive. The scope of the present disclosure is defined not by the above-described meaning, but by the claims, and all modifications within the meaning and range equivalent to the claims are intended to be encompassed therein.

Multiple claims set forth in the claims can be combined with each other, regardless of the form of reference. In the claims, there are multiple dependent claims that are dependent on multiple other claims. Although the claims do not include multiple dependent claims that are dependent on multiple dependent claims, multiple dependent claims dependent on multiple dependent claims may also be included.

1. A communication apparatus that is configured to wirelessly communicate with a mobile terminal and is to be mounted in a vehicle in which a plurality of seats are arranged, the communication apparatus comprising
a processing unit configured to execute processing,
wherein the processing unit
estimates a position of the mobile terminal inside the vehicle based on information obtained through communication with the mobile terminal,
specifies a seat closest to the estimated position among the plurality of seats,
acquires, from the mobile terminal, adjustment data needed to adjust the specified seat,
acquires data including whether or not permission to adjust a seat is indicated in advance, when acquiring the adjustment data from the mobile terminal, and
acquires the adjustment data from the mobile terminal only if the acquired data indicates permission to adjust a seat.

2. The communication apparatus according to claim 1, wherein the processing unit transmits the adjustment data acquired from the mobile terminal to a seat adjuster configured to adjust the specified seat among a plurality of seat adjusters configured to perform adjustment of the respective plurality of seats.

3. The communication apparatus according to claim 1, wherein the adjustment of the seat includes at least one of adjustment of a position in a front-rear direction of a bottom portion of the seat configured to come into contact with a gluteal region of an occupant of the vehicle, adjustment of a position in an up-down direction of the bottom portion, adjustment of an angle of a backrest that protrudes upward from a rear side of the bottom portion and is configured to come into contact with a back of the occupant, and adjustment of an angle of a headrest that protrudes upward from an upper end portion of the backrest and is configured to come into contact with a head region of the occupant.

4. The communication apparatus according to claim 1, wherein the adjustment data indicates a physique value relating to a physique of a person.

5. The communication apparatus according to claim 1,
wherein the processing unit determines whether or not an occupant of the vehicle has sat in one of the plurality of seats, and
if the processing unit determines that the occupant of the vehicle has sat in one of the plurality of seats, the processing unit estimates the position of the mobile terminal inside the vehicle based on information obtained through communication with the mobile terminal.

6. A communication system comprising:
a mobile terminal; and
a communication apparatus configured to communicate wirelessly with the mobile terminal and mounted in a vehicle in which a plurality of seats are arranged,
wherein the communication apparatus includes a processing unit configured to execute processing, and
the processing unit
estimates a position of the mobile terminal inside the vehicle based on information obtained through communication with the mobile terminal,
specifies a seat closest to the estimated position among the plurality of seats,
acquires, from the mobile terminal, adjustment data needed to adjust the specified seat,
acquires data including whether or not permission to adjust a seat is indicated in advance, when acquiring the adjustment data from the mobile terminal, and
acquires the adjustment data from the mobile terminal only if the acquired data indicates permission to adjust a seat.

7. A seat adjustment method for performing adjustment of one of a plurality of seats arranged in a vehicle, the method to be executed by a computer executing the steps of:
estimating, based on information obtained through wireless communication with a mobile terminal, a position of the mobile terminal inside the vehicle;
specifying a seat closest to the estimated position among the plurality of seats;
acquiring, from the mobile terminal, adjustment data needed to adjust the specified seat;
acquiring data including whether or not permission to adjust a seat is indicated in advance, when acquiring the adjustment data from the mobile terminal; and
acquiring the adjustment data from the mobile terminal only if the acquired data indicates permission to adjust a seat.

8. The communication apparatus according to claim 2, wherein the adjustment of the seat includes at least one of adjustment of a position in a front-rear direction of a bottom portion of the seat configured to come into contact with a gluteal region of an occupant of the vehicle, adjustment of a position in an up-down direction of the bottom portion, adjustment of an angle of a backrest that protrudes upward from a rear side of the bottom portion and is configured to come into contact with a back of the occupant, and adjustment of an angle of a headrest that protrudes upward from an upper end portion of the backrest and is configured to come into contact with a head region of the occupant.

9. The communication apparatus according to claim 2, wherein the adjustment data indicates a physique value relating to a physique of a person.

10. The communication apparatus according to claim 2,
wherein the processing unit determines whether or not an occupant of the vehicle has sat in one of the plurality of seats, and
if the processing unit determines that the occupant of the vehicle has sat in one of the plurality of seats, the processing unit estimates the position of the mobile terminal inside the vehicle based on information obtained through communication with the mobile terminal.
